(19) United States
(12) Patent Application Publication
(10) Pub. No.: US 2023/0071657 A1
(43) Pub. Date: Mar. 9, 2023

(54) DATA COLLECTION APPARATUS, DATA COLLECTION SYSYTEM, AND DATA COLLECTION METHOD

(71) Applicant: TOYOTA JIDOSHA KABUSHIKI KAISHA, Toyota-shi Aichi-ken (JP)

(72) Inventors: Daiki Yokoyama, Gotemba-shi Shizuoka-ken (JP); Tomohiro Kaneko, Mishima-shi Shizuoka-ken (JP)

(73) Assignee: TOYOTA JIDOSHA KABUSHIKI KAISHA, Toyota-shi Aichi-ken (JP)

(21) Appl. No.: 17/902,304

(22) Filed: Sep. 2, 2022

(30) Foreign Application Priority Data
Sep. 7, 2021 (JP) 2021-145710

(51) Int. Cl. H04L 41/16; H04L 51/06; H04L 51/21

(52) U.S. Cl. CPC H04L 41/16; H04L 51/06; H04L 51/21

(57) ABSTRACT

A data collection apparatus can communicates with a plurality of terminal devices located in a predetermined target area and respectively held by individuals, and collects data from the terminal devices. The data collection apparatus includes a transmission control unit for controlling transmission of data from the terminal devices; and a calculation unit for calculating the number of the terminal devices located in the target area. The transmission control unit controls transmission of data from the terminal devices so that when the number of the terminal devices located in the target area is relatively large, the transmission speed of data from the terminal devices is slower or the number of the terminal devices stopping transmission of data among the terminal devices located in the target area is larger than when the number of the terminal devices located in the target area is relatively small.

### CROSS REFERENCE TO RELATED APPLICATION

This application claims the benefit of priority from Japanese Patent Application No. 2021-145710 filed on Sep. 7, 2021, which is incorporated herein by reference in its entirety.

### TECHNICAL FIELD

The present disclosure relates to a data collection apparatus, a data collection system, and a data collection method.

### BACKGROUND

In smart cities, it has been proposed to collect data from multiple entities within the community. In particular, in JP2013-69084A1, since there is uncertainty in data obtained from information systems of different business entities, it has been proposed to collect data after correcting the obtained data in order to solve the uncertainty.

Incidentally, as one of the information sources in the smart city or the like, a terminal device (e.g., a wearable terminal) held by each person in the smart city is used. When a server acquires data from such a terminal device, if a large number of people are gathered, a large amount of data may be collected on the server, and the processing load on the server may be too high.

In view of the above problems, an object of the present disclosure is to prevent excessive load on a server when collecting data from a plurality of terminal devices held by individuals.

### SUMMARY

(1) A data collection apparatus communicating with and collecting data from a plurality of terminal devices located in a predetermined target area and respectively held by individuals, comprising:

a transmission control unit for controlling transmission of data from the terminal devices; and

a calculation unit for calculating a number of the terminal devices located in the target area, wherein

the transmission control unit controls the transmission of data from the terminal devices so that the transmission speed of data from the terminal devices is slower or the number of the terminal devices stopping transmission of data among the terminal devices located in the target area is larger when the number of the terminal devices located in the target area is relatively larger, than when the number of the terminal devices located in the target area is relatively smaller.

(2) The data collection apparatus according to above (1), wherein the transmission control unit controls the transmission of data from the terminal device so that the transmission speed of data from the terminal device decreases as the number of the terminal device located in the target area increases.

(3) The data collection apparatus according to above (1), wherein the transmission control unit controls the transmission of data from the terminal device so that the number of the terminal devices that stop the transmission of data among the terminal devices increases as the number of the terminal devices located in the target area increases.

(4) The data collection apparatus according to any one of above (1) to (3), wherein the terminal devices are configured to acquire environment information around the terminal devices, and

the transmission control unit controls the transmission of data related to the environment information from the terminal devices.

(5) The data collection apparatus according to any one of above (1) to (4), further comprising:

a training unit for training a machine learning model using data transmitted from the terminal devices; and

a model transmission unit for transmitting the machine learning model trained by the training unit to the terminal devices.

(6) A data collection system, including:

a plurality of terminal devices each held by an individual; and

a server for communicating with the plurality of terminal devices in a predetermined target area and collecting data from the terminal device, wherein

the server includes a transmission control unit for controlling transmission of data from the terminal devices, and a calculation unit for calculating a number of the terminal devices located in the target area,

the terminal device includes a data transmission unit for transmitting data acquired in the terminal device, based on a command from the transmission control unit, and

the transmission control unit controls the transmission of data by the data transmission unit so that the transmission speed of data from the terminal devices is slower or a number of the terminal device stopping the transmission of the data in the target area is larger, when the number of terminal devices located in the target area is relatively larger, than when the number of terminal devices located in the target area is relatively smaller.

(7) A data collection method for communicating with and collecting data from a terminal devices located within a predetermined target area and respectively held by individuals, the data collection method comprising:

calculating a number of the terminal devices located within the target area; and

controlling transmission of data from the terminal devices so that the transmission speed of data from the terminal devices is slower or a number of the terminal devices stopping the transmission of data among the terminal devices located within the target area is larger when the calculated number of the terminal devices is relatively larger, than when the calculated number of the terminal devices is relatively smaller.

### BRIEF DESCRIPTION OF THE DRAWINGS

FIG. 1 is a schematic configuration diagram of a machine learning system according to one embodiment.

FIG. 2 is a diagram schematically showing a hardware configuration of a terminal device.

FIG. 3 is a diagram schematically showing a hardware configuration of a server.

FIG. 4 is a diagram showing an example of an NN model having a simple configuration.

FIG. 5 is a functional block diagram of the processor of the terminal device.

FIG. 6 is a functional block diagram of a processor of the server.

FIG. 7 is an operation sequence diagram showing a flow of training process of a machine learning model used in a terminal device.

FIG. 8 is a diagram showing the relationship between the number of terminal devices located in the target area and the upper limit transmission speed of data from each terminal device to the server.

FIG. 9 is a diagram showing the relationship between the number of terminal devices located in the target area and the number of terminal devices that stop transmission of data to the server.

### DESCRIPTION OF EMBODIMENTS

Hereinafter, embodiments will be described in detail with reference to the drawings. In the following description, similar components are denoted by the same reference numerals.

### Configuration of the Machine Learning System

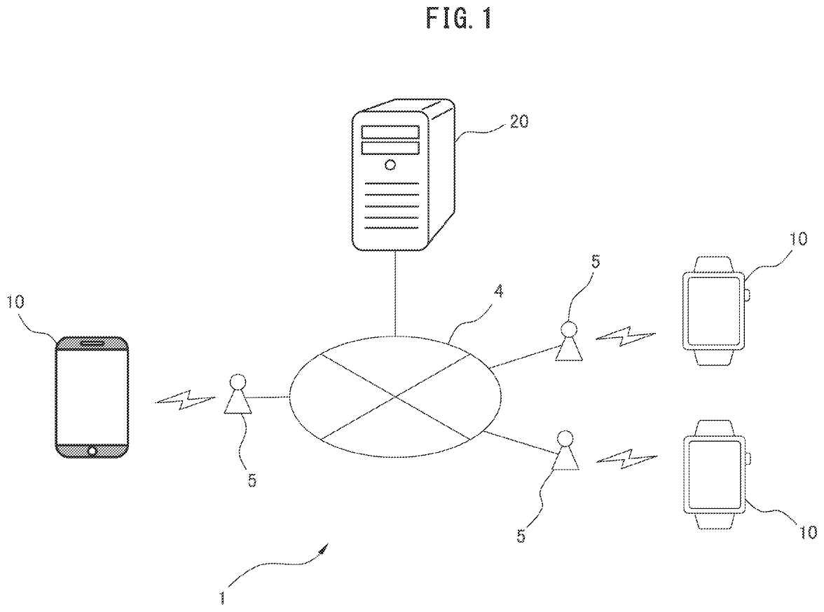

The configuration of the machine learning system 1 according to one embodiment will be described with reference to FIGS. 1 to 3. FIG. 1 is a schematic configuration diagram of a machine learning system 1 according to one embodiment. The machine learning system 1 trains a machine learning model used in each terminal device. The machine learning system also functions as a data collection system that collects data necessary for training the machine learning model from the terminal device.

As shown in FIG. 1, the machine learning system 1 includes a plurality of terminal devices 10 and a server 20 capable of communicating with the terminal devices 10. Each of the plurality of terminal devices 10 and the server 20 are configured to be able to communicate with each other via a communication network 4 configured by an optical communication line or the like and a wireless base station 5 connected to the communication network 4 via a gateway (not shown). As the communication between the terminal device 10 and the wireless base station 5, various wide area wireless communication having a long communication distance can be used, for example, communication that conforms to any communication standard such as 4G, LTE, or 5G, WiMAX established by 3GPP, IEEE is used.

In particular, in the present embodiment, the server 20 communicates with the terminal device 10 located within a predetermined target area. The target area is a range surrounded by predetermined boundaries. For example, a smart city may be defined as “a sustainable city or region that solves various problems faced by cities and regions and continues to create new value, through the sophistication of management (planning, maintenance, management, operation, etc.) while utilizing new technologies such as ICT (information and communication technology).” The server 20 may be capable of communicating with the terminal device 10 located outside the target area.

The terminal devices 10 are individually held devices. The terminal device 10 includes, for example, a wearable terminal such as a watch-type terminal (smart watch), a wristband-type terminal, a clip-type terminal, and an eyeglass-type terminal (smart glass), and a portable terminal. Therefore, the terminal device 10 moves along with the movement of the individual holding the terminal device 10. Therefore, when an individual holding the terminal device 10 moves into the target area, the terminal device 10 held by the individual also moves into the target area. Conversely, when an individual holding the terminal device 10 moves out of the target area, the terminal device 10 held by the individual also moves out of the target area.

In the present embodiment, the terminal device 10 includes, in particular, a watch-type terminal, and a portable terminal that communicates with the watch-type terminal by short-range wireless communication. As the short-range wireless communication, for example, communication conforming to any communication standard (for example, Bluetooth (™) or ZigBee (™)) established by IEEE, ISO, IEC, or the like is used.

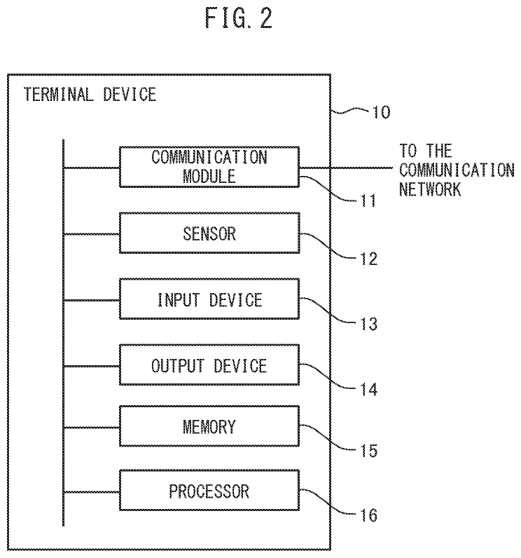

FIG. 2 is a diagram schematically showing a hardware configuration of the terminal device 10. As shown in FIG. 2, the apparatus includes a communication module 11, a sensor 12, an input device 13, an output device 14, a memory 15, and a processor 16. The communication module 11, the sensor 12, the input device 13, the output device 14 and the memory 15 are connected to the processor 16 via signal lines.

The communication module 11 is an example of a communication unit that communicates with other devices. The communication module 11 is, for example, a device for communicating with the server 20. In particular, the communication module 11 is a device that communicates with the wireless base station 5 through the wide area wireless communication described above, so that the communication module 11 communicates with the server 20 through the wireless base station 5 and the communication network 4.

The sensor 12 is an example of a detector that detects various parameters relating to the situation of terminal device 10 and the situation around terminal device 10. In particular, the sensor 12 has a plurality of discrete sensors that detect different parameters. The values of the various parameters detected by the sensor 12 are transmitted to the processor 16 or the memory 15 via signal lines.

Specifically, the sensor 12 includes a GNSS receiver that detects the present position of the terminal device 10. The sensor 12 may also include a sensor for detecting parameters relating to a user holding the terminal device 10. For example, when the terminal device 10 is a watch-type terminal (smart watch), the sensor 12 may include a sensor for detecting data (e.g., vital signs (heart rate, body temperature, blood pressure, and respiration rate), blood oxygen concentration, electrocardiogram, blood glucose level, number of steps, calorie consumption, fatigue, sleep state, etc.) relating to the physical condition of the user wearing the terminal device 10.

The sensor 12 may also include a sensor for detecting environmental information about the terminal device 10. For example, when the terminal device 10 is a glasses-type terminal (smart glass), the sensor 12 includes, in addition to the sensors detecting the values of the parameters relating to the status of the user, for example, cameras provided in the glasses-type terminal for capturing what the user is seeing, and distance sensors (millimeter-wave radar, LIDAR, or the like) for detecting the distance to what the user is seeing.

The input device 13 is a device for the user of the terminal device 10 to input information. Specifically, the input device 13 includes a touch panel, a microphone, a button, a dial, and the like. Information input via the input device 13 is transmitted to the processor 16 or the memory 15 via a signal line.

The output device 14 is a device for the terminal device 10 to provide output. Specifically, the output device 14 includes a display, a speaker, or the like. The output device 14 performs output based on a command transmitted from the processor 16 via a signal line. For example, the display displays an image on the screen based on commands from the processor 16, and/or the speaker outputs sound based on instructions from the processor 16.

The memory 15 includes, for example, a volatile semiconductor memory (e.g., RAM), a nonvolatile semiconductor memory (e.g., ROM), and the like. The memory 15 stores a computer program for executing various processing in the processor 16, various data used when various processing is executed by the processor 16, and the like. The memory 15 stores, for example, a machine learning model, specifically, the configuration of the machine learning model and model parameters (such as weights and biases, which will be described later).

The processor 16 includes one or more CPUs (Central Processing Unit) and peripheral circuits thereof. The processor 16 may further comprise an arithmetic circuit, such as a logical arithmetic unit or a numerical arithmetic unit. The processor 16 executes various kinds of processing based on a computer program stored in the memory 15. Specific processing executed by the processor 16 of the terminal device 10 will be described later.

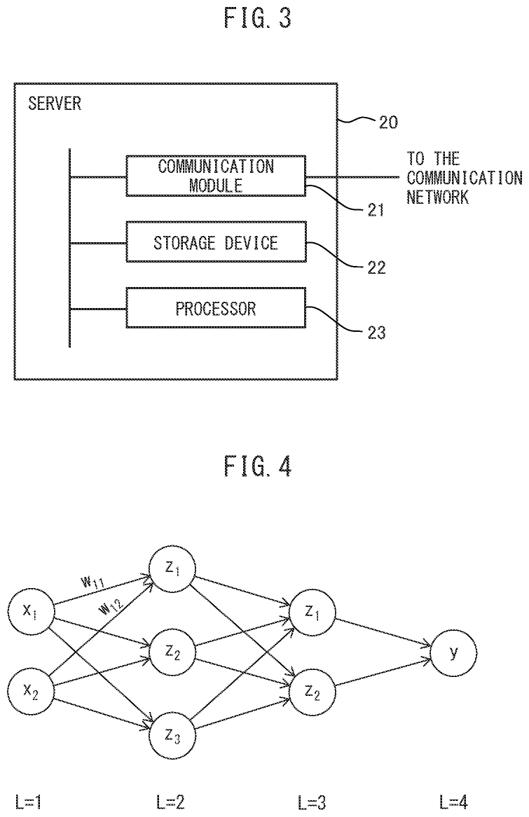

FIG. 3 is a diagram schematically showing a hardware configuration of the server 20. The server 20 includes a communication module 21, a storage device 22, and a processor 23, as illustrated in FIG. 3. The server 20 may include an input device such as a keyboard and a mouse, and an output device such as a display.

The communication module 21 is an example of a communication unit for communicating with devices outside the server 20. The communication module 21 comprises an interface circuit for connecting the server 20 to the communication network 4. The communication module 21 is configured to communicate with each of the plurality of terminal devices 10 via the communication network 4 and the wireless base station 5.

The storage device 22 is an example of a storage unit for storing data. The storage device 22 includes, for example, a hard disk drive (HDD), a solid state drive (SSD), or an optical recording medium. The storage device 22 may include a volatile semiconductor memory (e.g., RAM), a nonvolatile semiconductor memory (e.g., ROM), or the like. The storage device 22 stores a computer program for executing various processing by the processor 23 and various data used when various processing is executed by the processor 23. The storage device 22 stores machine learning data transmitted from the terminal device 10.

The processor 23 has one or a plurality of CPUs and peripheral circuits thereof. The processor 23 may further comprise a GPU or an arithmetic circuit, such as a logical arithmetic unit or a numeric arithmetic unit. The processor 23 executes various kinds of processing based on a computer program stored in the storage device 22. Specific processing executed by the processor 23 of the server 20 will be described later.

### Machine Learning Model

In the present embodiment, in the terminal device 10, the machine learning model subjected to the machine learning is used when the function provided in the terminal device 10 is executed. In the present embodiment, for example, a neural network model (hereinafter referred to as “NN model”) is used as the machine learning model. Hereinafter, an outline of the NN model will be described with reference to FIG. 4. FIG. 4 is a diagram showing an example of an NN model having a simple configuration.

The circles in FIG. 4 represent artificial neurons. The artificial neurons are usually referred to as nodes or units (referred to herein as “nodes”). In FIG. 4, L=1 denotes an input layer, L=2 and L=3 denote a hidden layer, and L=4 denotes an output layer.

In FIG. 4, x₁ and x₂ indicate each node of the input layer (L=1) and the output value from that node, and y indicates the node of the output layer (L=4) and its output value. Similarly, z₁^{(L=2)}, z₂^{(L=2)} and z₃^{(L=2)} indicate each node of the hidden layer (L=2) and the output value from that node, and z₁^{(L=3)} and z₂^{(L=3)} indicate each node of the hidden layer (L=3) and the output value from that node.

Input is output as-is at each node of the input layer. On the other hand, the output value x₁ and x₂ of each node of the input layer are input to each node of the hidden layer (L=2), and the total input value u is calculated in each node of the hidden layer (L=2) using the corresponding weights w and b, respectively. For example, the total input value uₖ^{(L=2)} calculated at each node shown by zₖ^{(L=2)} (k=1, 2, 3) of the hidden layer (L=2) in FIG. 4 is as follows (M is the number of nodes of the input layer).

$${u}_{k}^{( L = 2 )} = {\sum }_{m = 1}^{M} ( {x}_{m} \cdot {w}_{km}^{( L = 2 )} ) + {b}_{k}$$

Then, the total input value uₖ^{(L=2)} is converted by the activation function f, and the converted value is output as the output value zₖ^{(L=2)}(=f(uₖ^{(L=2)}) from the node indicated by zₖ^{(L=2)} of the hidden layer (L=2). On the other hand, the output value z₁^{(L=2)}, z₂^{(L=2)} and z₃^{(L=2)} of each node of the hidden layer (L=2) are inputted to each node of the hidden layer (L=3). In each node of the hidden layer (L=3), the total input value u (=Σz·w+b) is calculated using the corresponding weights w and biases b, respectively. The total input value u is converted by the activation function in the same way, and is output as the output value z₁^{(L=3)}, z₂^{(L=3)} from each node of the hidden layer (L=3). The activation function is, for example, ReLU function σ.

The output value z^{(L=3)} and z₂^{(L=3)} of each node of the hidden layer (L=3) are input to the node of the output layer (L=4). In the node of the output layer, the total input value u (Σz·w+b) is calculated using the corresponding weights w and biases b, respectively. For example, a sigmoid function or an identity function is used as an activation function in a node of the output layer. In this case, the total input value u calculated at the node of the output layer is directly output from the node of the output layer as the output value y.

Thus, the NN model includes an input layer, a hidden layer, and an output layer, and when one or more input parameters are input from the input layer, one or more output parameters corresponding to the input parameters are output from the output layer. In the NN model shown in FIG. 4, the number of layers of the hidden layer is two, but the number of layers of the hidden layer can be any number. In the NN model shown in FIG. 4, the number of nodes in the input layer is 2, the number of nodes in the output layer is 1, and the number of nodes in the hidden layer is 3 or 2, but the number of nodes in each layer can be any number. Further, although FIG. 4 shows the simplest NN model as a machine learning model, the machine learning model may be any model as long as it is a model capable of machine learning based on the collected data. Thus, the machine learning model may be, for example, a recurrent neural network (RNN), a reinforcement learning model, etc.

In the present embodiment, a machine learning model, for example, is used in which, when vital signs such as body temperature, heart rate, blood pressure, and respiration rate of a user holding the terminal device 10, and environmental information such as air temperature and humidity around the terminal device 10 are input as input parameters, a probability of suffering from heat stroke (hereinafter, referred to as a “probability of heat stroke”) is output as an output parameter. In this case, the temperature and humidity around the terminal device 10 may be detected by the sensor 12 of the terminal device 10, or may be transmitted from the server 20 via the communication network 4.

Note that a model having various input parameters and output parameters can be used as the machine learning model. The input parameters include various parameters that can be detected by the sensor 12 of the terminal device 10. Specifically, the input parameters include, for example, vital signs (heart rate, body temperature, blood pressure, and respiration rate), blood oxygen concentration, electrocardiogram, blood glucose level, number of steps, calorie consumption, fatigue, sleep state, time, image, moving image, and the like. The input parameters may include parameters transmitted from the server 20 via the communication network 4 (for example, the temperature, humidity, weather, wind speed, and the like around the terminal device 10).

In the present embodiment, the machine learning of the NN model as described above is performed not by the terminal device 10 but by the server 20. The machine learning of the NN model uses the training data set including the value of the parameter detected by the sensor 12 of the terminal device 10. In addition, the training data set includes the values of the parameters associated with the output parameters of the NN model as ground truth values (ground truth labels). For example, in the case where the probability of heat stroke is an output parameter as described above, the value of the output parameter is set to 1 in the training data set created for the person suffering from heat stroke. On the other hand, the value of the output parameter is set to 0 in the training data set created for the person who has not suffered from heat stroke. The training data set may be generated by performing preprocessing (processing for missing data, normalization, standardization, etc.) on the output value of the sensor 12.

In machine learning of the NN model, for example, the weights w and the biases b in the NN model are repeatedly updated by the well-known error back-propagation method so that the difference between the output value of the NN model and the ground truth value of the output parameter included in the training data set becomes small. As a result, the NN model is trained, and a trained NN model is generated. For the machine learning in the machine learning model, any known technique can be used. In this specification, parameters whose values are updated by training (for example, the weight w and the bias b) are referred to as model parameters.

### Use of Machine Learning Models

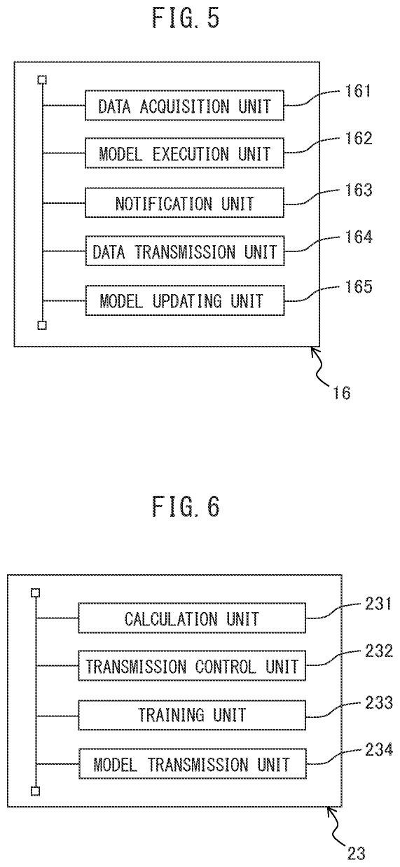

Next, processing using the machine learning model in the terminal device 10 will be described with reference to FIG. 5. In the present embodiment, the terminal device 10 calculates the probability of heat stroke of the user holding the terminal device 10, based on the values of the various parameters detected by the sensor 12 of the terminal device 10. In addition, the terminal device 10 notifies the user that there is a risk of heat stroke when the probability of heat stroke is equal to or higher than a certain reference value.

FIG. 5 is a functional block diagram of the processor 16 of the terminal device 10. As shown in FIG. 5, the processor 16 of the terminal device 10 includes a data acquisition unit 161, a model execution unit 162, and a notification unit 163, in order to estimate the probability of heat stroke. These functional blocks of the processor 16 of the terminal device 10 are functional modules implemented, for example, by a computer program running on the processor 16. Alternatively, the functional blocks included in the processor 16 may be dedicated arithmetic circuits provided in the processor 16.

The data acquisition unit 161 acquires data relating to input parameters of the machine learning model. Specifically, the data acquisition unit 161 acquires the value of the input parameter detected by the sensor 12 of the terminal device 10. In the present embodiment, the data acquisition unit 161 acquires the body temperature, the heart rate, the blood pressure, and the respiration rate of the user from the sensor 12. The data acquisition unit 161 may acquire the value of the input parameter from an external device such as the server 20 via the communication module 11. In the present embodiment, the server 20, when receiving the current position detected by the sensor 12 of each terminal device 10 from each terminal device 10, transmits the current temperature and the current humidity around the position to the terminal device 10. Therefore, the data acquisition unit 161 acquires the temperature and humidity around the terminal device 10 from the server 20. The data acquired by the data acquisition unit 161 is stored in the memory 15.

When the data acquisition unit 161 acquires the current value of the input parameter of the machine learning model, the model execution unit 162 inputs the acquired value of the input parameter to the machine learning model, and calculates the value of the output parameter. In the present embodiment, when the body temperature, heart rate, blood pressure, and respiration rate of the user and the air temperature and humidity around the terminal device 10 acquired by the data acquisition unit 161 are input to the machine learning model, the model execution unit 162 outputs the user's probability of heat stroke.

Here, the program for executing the machine learning model and the values of the model parameters used in the machine learning model are stored in the memory 15. Therefore, the model execution unit 162 calculates the value of the output parameter using the program and the values of the model parameter stored in the memory 15.

The notification unit 163 notifies the user, based on the value of the output parameter calculated by the model execution unit 162. The notification unit 163 notifies the user through the output device 14. More specifically, in the present embodiment, the notification unit 163 notifies the user by the output device 14 when the probability of heat stroke calculated by the model execution unit 162 is equal to or greater than a predetermined reference value (e.g., 25%). In this case, for example, the notification unit 163 may display a warning regarding heat stroke on the display, or may generate a warning sound regarding heat stroke from a speaker. Note that the notification unit 163 may always display the calculated probability of heat stroke on the display regardless of the probability of heat stroke.

### Training of Machine Learning Models

Next, the training process of the machine learning model will be described with reference to FIGS. 5 to 8. In the present embodiment, the training of the machine learning model is performed by the server 20, based on data detected by the sensor 12 of each terminal device 10.

As shown in FIG. 5, the processor 16 of the terminal device 10 includes a data transmission unit 164 and a model updating unit 165 for training the machine learning model. These functional blocks of the processor 16 of the terminal device 10 are functional modules implemented, for example, by a computer program running on the processor 16. Alternatively, the functional blocks included in the processor 16 may be dedicated arithmetic circuits provided in the processor 16.

The data transmission unit 164 transmits the data acquired by the sensor 12 of the terminal device 10 by the data acquisition unit 161 to the server 20 via the communication network 4. The data transmitted to the server 20 includes the values of the input parameters of the machine learning model, since the data is used to train the machine learning model. When the value of the output parameter is detected by the sensor 12 of the terminal device 10, for example, when the machine learning model is a model that estimates the future value of the output parameter from the value of the input parameter, the data transmitted to the server 20 may include the value of the output parameter.

In particular, in the present embodiment, the data transmission unit 164 transmits data to the server 20 in accordance with a command from the transmission control unit 232 of the server 20, which will be described later. Therefore, when the upper limit transmission speed to the server 20 is notified from the transmission control unit 232 of the server 20, the data transmission unit 164 transmits the data to the server 20 at the notified upper limit transmission speed or less. Specifically, for example, when the data acquisition unit 161 acquires data at a certain cycle, the data transmission unit 164 transmits only a part of the acquired data to the server 20 at a fixed cycle longer than the data acquisition cycle.

The model updating unit 165 updates the machine learning model used by the model execution unit 162. In this embodiment, when the training of the machine learning model is completed in the server 20, the trained machine learning model is transmitted from the server 20 to each terminal device 10. The model updating unit 165 updates the machine learning model used by the model execution unit 162 to the machine learning model transmitted from the server 20. Specifically, the model updating unit 165 updates the value of the model parameter of the machine learning model used by the model execution unit 162 to the value of the model parameter transmitted from the server 20. As a result, the model execution unit 162 calculates the value of the output parameter using the trained machine learning model.

Next, training of the machine learning model in the server 20 will be described with reference to FIG. 6. In training the machine learning model, data including input parameters of the machine learning model is transmitted to the server 20 from the terminal device 10 in the predetermined target area. In particular, in the present embodiment, the transmission of data from the terminal devices 10 to the server 20 is controlled so that the transmission speed of data from each terminal device 10 when the number of terminal devices 10 in the target area is relatively large is lower than that that when the number of terminal devices 10 in the target area is relatively small.

FIG. 6 is a functional block diagram of the processor 23 of the server 20. As shown in FIG. 6, the processor 23 of the server 20 includes a calculation unit 231, a transmission control unit 232, a training unit 233, and a model transmission unit 234.

The calculation unit 231 calculates the number of terminal devices 10 located within a preset target area. Specifically, the calculation unit 231 determines whether or not the terminal device 10 is located within the target area, based on the current position included in the data transmitted from each terminal device 10. Then, the calculation unit 231 calculates the number of terminal devices 10 determined to be located within the target area.

The target area may be an area that can communicate with the server 20 through the communication network 4. In this case, the calculation unit 231 calculates the number of the terminal devices 10 that have transmitted the data to the server 20 through communication with the server 20, as the number of the terminal devices 10 located in the target area.

The calculation unit 231 may calculate the number of the terminal devices 10 in which the corresponding application software is installed among the terminal devices 10 rather than the number of all the terminal devices 10 located in the target area. In the present embodiment, the corresponding application software is, for example, application software for calculating the probability of heat stroke based on the output value of the sensor 12 of the terminal device 10 or the like.

The transmission control unit 232 controls the transmission of data from each terminal device 10. The transmission control unit 232 controls, for example, the transmission speed of data from each terminal device 10. In this case, for example, the transmission control unit 232 notifies each terminal device 10 of the upper limit transmission speed of the data to the server 20. The data transmission unit 164 of each terminal device 10 that has received the notification of the upper limit transmission speed from the transmission control unit 232 transmits data to the server 20 at a transmission speed lower than or equal to the upper limit transmission speed transmitted from the transmission control unit 232.

The training unit 233 trains the machine learning model, based on the data transmitted from the terminal devices 10. In the present embodiment, the training unit 233 creates a training data set based on the data transmitted from the terminal devices 10, and causes the machine learning model to be trained using the created training data set.

In the present embodiment, when the user suffers from heat stroke, the information is input to the terminal device 10 by the user via the input device 13. The information on the occurrence of heat stroke input to the terminal device 10 is transmitted to the server 20 via the communication network 4. The heat stroke information is used as a ground truth value associated with data transmitted to the server 20 in the past for the user (i.e., the probability of heat stroke, which is an output parameter, is set to 1) and a training data set is created.

Alternatively, when the user suffers from heat stroke, the information is input by the medical institution that diagnosed the user, via a terminal device (not shown) connected to the communication network 4. The information on the occurrence of heat stroke input by the terminal device of the medical institution is transmitted to the server 20 via the communication network 4. The heat stroke information is used as a ground truth value associated with data transmitted to the server 20 in the past for the user (i.e., the probability of heat stroke, which is an output parameter, is set to 1), and a training data set is created. On the other hand, the past data that was not linked to the heat stroke suffering information is combined with the ground truth value that the heat stroke did not occur (i.e., the probability of heat stroke, which is an output parameter, is set to 0) to generate a training data set. Therefore, the created training data set is a data set including the actual measured value of the input parameter of the machine learning model and the ground truth value (ground truth label) of the output parameter of the machine learning model.

Then, the training unit 233 uses the training data set created in the above manner to train the machine learning model by a technique such as the error back propagation method as described above. Specifically, the training unit 233 updates the values of the model parameters of the machine learning model using the training data set.

The model transmission unit 234 transmits the trained machine learning model subjected to the machine learning by the training unit 233 to each terminal device 10 via the communication network 4. Specifically, the value of the model parameter updated by the training by the training unit 233 is transmitted to each terminal device 10. As described above, the model updating unit 165 of each terminal device 10 updates the machine learning model used by the model execution unit 162 to the machine learning model transmitted by the model transmission unit 234.

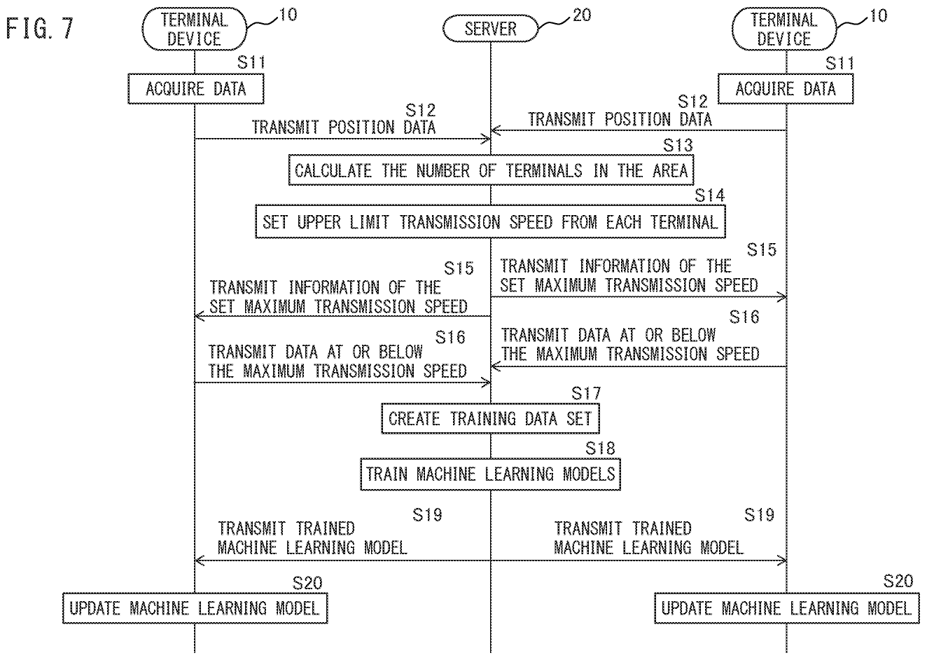

FIG. 7 is an operation sequence diagram showing a flow of training process of a machine learning model used in the terminal device 10. The training process illustrated in FIG. 7 is executed in the processor 16 of the terminal device 10 and the processor 23 of the server 20.

In the training process in the present embodiment, as shown in FIG. 7, the data acquisition unit 161 of the processor 16 of each terminal device 10 periodically acquires various data from the sensor 12 (Step S11). The data acquired by the data acquisition unit 161 includes data relating to the current position of the terminal device 10 in addition to the values of the input parameters of the machine learning model.

The data transmission unit 164 of each terminal device 10 periodically transmits the data of the current position of each terminal device 10 acquired by the data acquisition unit 161 to the server 20 (Step S12). The cycle in which each terminal device 10 transmits the data of the current position to the server 20 may be the same cycle as the cycle in which the data is acquired from the data acquisition unit 161 or the sensor 12, or may be a cycle longer than the cycle.

The calculation unit 231 of the server 20, when receiving the data of the current position from a large number of terminal devices 10, calculates the number of terminal devices 10 located in the target area, based on the data of the current position of each terminal device 10 transmitted from the terminal device 10 (Step S13). Specifically, the calculation unit 231 determines whether or not the current position of the terminal device 10 is located within the target area for each terminal device 10, and counts the number of the terminal devices 10 determined to be located within the target area.

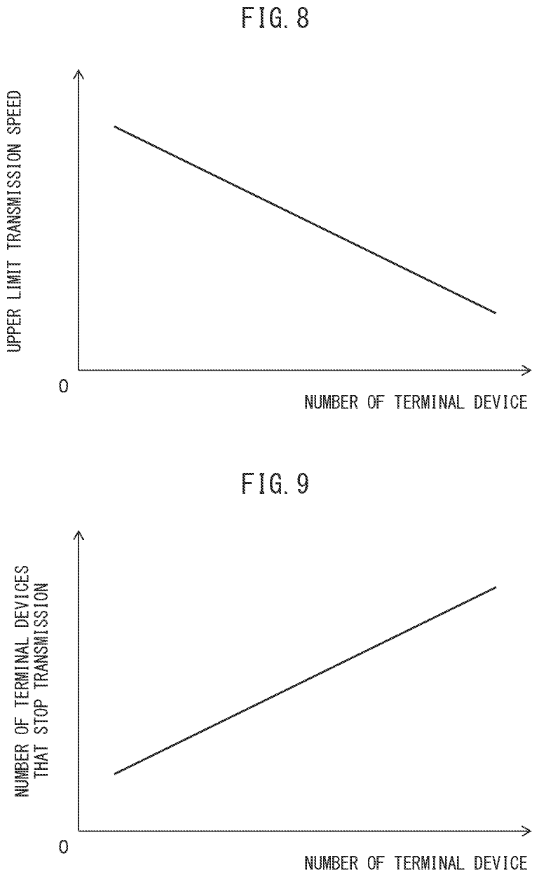

If the number of terminal devices 10 located in the target area is calculated, the transmission control unit 232 of the server 20 sets the upper limit transmission speed from each terminal device 10 to the server 20, based on the number of terminal devices 10 located in the target area calculated by the calculation unit 231 (Step S14). FIG. 8 is a diagram showing the relationship between the number of terminal devices 10 located in the target area calculated by the calculation unit 231 in step S13 and the upper limit transmission speed of data from each terminal device 10 to the server 20. As shown in FIG. 8, in the present embodiment, the transmission control unit 232 sets the upper limit transmission speed so that the upper limit transmission speed of data from each terminal device 10 becomes lower as the number of terminal devices 10 located in the target area increases. The upper limit transmission speed may be set to the same speed for all the terminal devices 10, or may be set to be faster for the terminal device 10 having a larger amount of information.

When the upper limit transmission speed from each terminal device 10 to the server 20 changes in this manner, the actual transmission speed from each terminal device 10 to the server 20 also changes. Basically, the lower the upper limit transmission rate, the lower the actual transmission rate. Therefore, in the present embodiment, it can be said that the transmission control unit 232 controls the transmission of data from each terminal device 10 so that the transmission speed of the data from each terminal device 10 becomes lower as the number of terminal devices 10 located in the target area increases.

Then, upon setting the upper limit transmission speed from each terminal device 10, the transmission control unit 232 transmits the information of the set upper limit transmission speed to each terminal device 10 via the communication network 4 (Step S15).

Upon receiving the information of the upper limit transmission speed from the server 20, the data transmission unit 164 of the terminal device 10 transmits data necessary for training of the machine learning model (Step S16). At this time, the data transmission unit 164 transmits the data to the server 20 so that the transmission speed to the server 20 is equal to or lower than the upper limit transmission speed transmitted from the transmission control unit 232 in step S15. Specifically, the data transmission unit 164, for example, changes the cycle for transmitting data to the server 20 so that the transmission speed to the server 20 is equal to or lower than the upper limit transmission speed. Therefore, when the cycle for transmitting data to the server 20 is long, the data transmission unit 164 does not transmit a part of the data acquired by the data acquisition unit 161 to the server 20.

When the training unit 233 of the server 20 receives data necessary for training of the machine learning model from each terminal device 10, it creates a data set for training based on these data (Step S17). The training unit 233 collects the values of the input parameters detected by the sensors 12 of the terminal devices 10 and the values of the output parameters (ground truth values) corresponding to the terminal devices 10 acquired from the terminal devices 10 or other terminal devices, and creates a training data set. In addition, the training unit 233 may generate a training data set by collecting parameters related to the terminal device 10 based on the positional information of the terminal device 10 (such as air temperature and humidity around the terminal device 10), in addition to the above parameters.

In addition, when the creation of the training data set is completed and the training data sets necessary for the training of the machine learning model are prepared, the training unit 233 performs the training of the machine learning model (Step S18). The training of the machine learning model is performed by a known method such as the error back propagation method as described above.

When the training of the machine learning model by the training unit 233 is completed, the model transmission unit 234 transmits the trained machine learning model to the terminal devices 10 (Step S19). Upon receiving the trained machine learning model, the model updating unit 165 of the terminal device 10 updates the machine learning model used by the model execution unit 162 to the machine learning model transmitted from the server 20 (Step S20).

### Effects and Modifications

In this embodiment, data is transmitted from each terminal device to the server 20 in this manner, and the server 20 updates the machine learning model to the trained model based on such data. By updating the machine learning model on the basis of the actual measurement values of the sensors 12 of the terminal device 10 in this manner, it is possible to perform highly accurate estimation using the machine learning model (for example, it is possible to estimate the probability of heat stroke with high accuracy).

Further, in the present embodiment, as the number of terminal devices 10 located in the target area increases, the upper limit transmission speed of data from each terminal device 10 to the server 20 decreases, and as a result, the transmission speed from each terminal device 10 to the server 20 decreases. As a result, even if the number of the terminal device 10 located in the target area is increased, it is possible to suppress the total amount of data transmitted to the server 20 to be increased. Therefore, when collecting data from the terminal device 10, the amount of data received by the server 20 is suppressed to be excessively large, and thus the processing load of the server 20 is suppressed to be excessively high.

In the above embodiment, as shown in FIG. 8, the upper limit transmission speed is continuously set in accordance with the number of terminal devices 10 so that the upper limit transmission speed of data from the terminal device 10 becomes lower as the number of terminal devices 10 located in the target area increases. However, the upper limit transmission speed may be set stepwise in accordance with the number of the terminal devices 10 so that the upper limit transmission speed of data from the terminal device 10 becomes lower as the number of the terminal devices 10 located in the target area increases. Therefore, for example, the upper limit transmission speed may be set to the first speed when the number of terminal devices 10 located in the target area is less than the predetermined number, and the upper limit transmission speed may be set to the second speed lower than the first speed when the number of terminal devices 10 located in the target area is equal to or greater than the predetermined number. In any case, the transmission control unit 232 control the transmission of data from each terminal device so that the transmission speed of data from each terminal device 10 is slower when the number of the terminal devices 10 located in the target area is relatively larger, as compared with when the number of the terminal devices 10 located in the target area is relatively smaller.

In the above embodiment, the transmission control unit 232 controls the transmission speed of data from the terminal device 10 in accordance with the number of the terminal devices 10 located in the target area. However, the transmission control unit 232 may control the number of terminal devices 10 that stop transmission of data to the server 20 among the terminal devices 10 located in the target area, according to the number of the terminal devices 10 located in the target area.

In this case, as shown in FIG. 9, the transmission control unit 232 controls the number of terminal devices 10 that stop transmission of data continuously according to the number of terminal devices 10 so that the number of terminal devices 10 that stop transmission of data to the server 20 among the terminal devices 10 located in the target area increases as the number of terminal devices 10 located in the target area increases. Alternatively, the transmission control unit 232 may control the number of the terminal devices 10 that stop transmission of data in stages according to the number of the terminal devices 10 so that the number of the terminal devices 10 that stop transmission of data increases as the number of the terminal devices 10 located in the target area increases. In any case, the transmission control unit 232 controls the transmission of data from each terminal device 10 so that the number of terminal devices 10 among the terminal devices 10 located in the target area to be stopped is larger when the number of terminal devices 10 located in the target area is relatively larger, than when the number of terminal devices 10 located in the target area is relatively smaller.

Specifically, the transmission control unit 232 notifies a part of the terminal device 10 located in the target area to stop the transmission of data to the server 20. In this case, the server 20 does not particularly notify the terminal device 10 that permits transmission of data to the server 20, but notifies only the terminal device 10 that stops transmission of data to the server 20. The data transmission unit 164 of the terminal device 10 notified that the transmission of data from the transmission control unit 232 to the server 20 is prohibited does not transmit the acquired data to the server 20 even if the data is acquired by the data acquisition unit 161.

Further, in the above embodiment, as the machine learning model, a model for estimating the probability of heat stroke from the vital signs or the like of the user detected by the sensor 12 of the terminal device 10 is used. However, as described above, as long as the model uses the data detected by the sensor 12 of the terminal device 10 as the input parameter, various models can be used as the machine learning model.

For example, when the sensor 12 of the terminal device 10 includes a sensor for detecting environmental information around the terminal device 10 such as a camera, the sensor 12 of the terminal device 10 acquires data relating to environmental information such as an image or a moving image around the terminal device 10 captured by the camera. In this case, the transmission control unit 232 of the server 20 controls at least the transmission of the data relating to the environment information from each terminal device 10.

In this case, for example, the machine learning model is a model in which, when an image or moving image acquired by the sensor 12 of the terminal device 10 is input, an object to be detected (e.g., a person taking suspicious behavior) in the image or moving image is detected.

When the environment information around the terminal device 10 is acquired in this manner, if there are many terminal devices 10 in the target area, the plurality of terminal devices 10 acquire the same data for the same environment. Therefore, when receiving data from all the terminal devices 10, duplicate data from the plurality of terminal devices 10 will be received. On the other hand, when many terminal devices 10 are located in the target area, it is possible to suppress the redundant data to be transmitted to the server 20 by slowing the transmission speed of data to the server 20 from each terminal device 10 or by stopping the transmission of data from a part of the terminal device 10 to the server 20.

While several embodiments of the present disclosure have been described above, the present disclosure is not limited to these embodiments, and various modifications and changes may be made within the scope of the appended claims.

1. A data collection apparatus communicating with and collecting data from a plurality of terminal devices located in a target area and respectively held by individuals, comprising a processor:
the processor being configured to:
control transmission of data from the terminal devices; and
calculate a number of the terminal devices located in the target area, wherein
the processor is configured to control the transmission of data from the terminal devices so that the number of the terminal devices that stop the transmission of data among the terminal devices located in the target area increases as the number of the terminal devices located in the target area increases.

2. (canceled)

3. (canceled)

4. The data collection apparatus according to claim 1, wherein the terminal devices are configured to acquire environment information around the terminal devices, and
the processor is configured to control the transmission of data related to the environment information from the terminal devices.

5. The data collection apparatus according to claim 1, wherein the processor is configured to:
train a machine learning model using data transmitted from the terminal devices; and
transmit the trained machine learning model to the terminal devices.

6. A data collection system, including:
a plurality of terminal devices each held by an individual; and
a server for communicating with the plurality of terminal devices in a target area and collecting data from the terminal devices, wherein
the server is configured to: control transmission of data from the terminal devices; and calculate a number of the terminal devices located in the target area,
the terminal devices are configured to transmit data acquired in the terminal devices, based on a command from the server, and
the server is configured to control the transmission of data from the terminal devices so that the number of the terminal devices that stop the transmission of data among the terminal devices located in the target area increases, as the number of the terminal devices located in the target area increases.

7. A data collection method for communicating with and collecting data from terminal devices located within a target area and respectively held by individuals, the data collection method comprising:
calculating a number of the terminal devices located within the target area; and
controlling transmission of data from the terminal devices so that the number of the terminal devices stopping the transmission of data among the terminal devices located in the target area increases as the calculated number of the terminal devices increases.
